(19) United States
(12) Patent Application Publication
(10) Pub. No.: US 2012/0219929 A1
(43) Pub. Date: Aug. 30, 2012

(54) METHOD FOR FIXING A SUPERSTRUCTURE ON IMPLANTS AND SET FOR APPLYING THIS METHOD

(76) Inventors: René De Clerck, Tervuren (BE); Ali Tahmaseb, Schoten (BE)

(21) Appl. No.: 13/505,218

(22) PCT Filed: Nov. 3, 2010
(86) PCT No.: PCT/BE2010/000076

§ 371 Date: Apr. 30, 2012

(30) Foreign Application Priority Data
Oct. 30, 2009 (BE) BE 2009/0673

(51) Int. Cl. A61C 8/00

(52) U.S. Cl. 433/174; 433/173

(57) ABSTRACT

The invention relates to a method for mounting a superstructure (19) of a dental prothesis on implants (1) which are provided in the bone (24) of a patient's lower or upper jaw (25), whereby these implants (1) form loadable (1a, 1c) and non-loadable (1b) implants. The superstructure (19) is fixed on the head (4) of the loadable implants (1a, 1b), whereby a supporting element (2) is mounted between said head (4) and the superstructure (19), whereas a free space (26) is preserved between the head (4) of the non-loadable implants (1b) and the superstructure (19). The invention also concerns a set with a superstructure (19) for a dental prothesis and with at least one supporting element (2), a fastening screw (20) and an implant (1) for applying the method.

The invention concerns a method for mounting a superstructure of a dental prothesis on implants provided in the bone of a patient's lower or upper jaw, whereby each of these implants has a head on which said superstructure must be fixed.

According to the present state of the art, it is possible to mount a superstructure immediately after implants have been placed in a jaw in order to mount these implants. This is called “immediate loading” of the implants.

The techniques making this possible are usually based on a three-dimensional image of the jaw. On the basis of this image is selected a position in the jaw for the implants to be provided, which reckons for example with any critical structures in the jaw, such as for example the position of nerve bundles or the jaw's bone structure.

Starting from this selected position for the implants and the type of implants that was chosen, a template and a superstructure are then made with great accuracy via CAD-CAM or what is called a prototype manufacturing technique. Such a method is described for example in document WO 03/003933.

By means of the produced template, bore holes are made in predetermined positions in the jaw's bone, and implants are subsequently placed in these bore holes. These implants are placed with great precision, for example by means of the template of the method described in document WO 2008/009080.

Almost immediately after the implants have been placed in the jaw's bone, a superstructure, provided with a dental prothesis, is mounted on the implants.

In certain cases, however, it is not possible to immediately load all the provided implants by mounting a superstructure. This is the case, for example, when the implant is only partly surrounded by the jaw's bone and for example a part of the implant is embedded in artificial bone and surrounded by a membrane. For such an implant, the loading must be postponed until it is entirely surrounded by newly grown bone. Thus, it is impossible for such an implant to be immediately loaded after having been placed in the bone.

Further, it is found that in certain cases, for example because of the characteristics of the jaw's bone, an implant must be provided which is different from the initially planned type of implant. Thus, it may be required for example to place an implant having a larger diameter than the implant that had been initially chosen and that was taken as a basis to manufacture the superstructure.

The invention aims to remedy these problems by proposing a method which makes it possible to mount a superstructure in the patient's oral cavity immediately after the implants have been placed in the jaw, although one or several implants possibly may not or cannot be immediately loaded.

Apart from that, the invention makes it possible to mount a superstructure on practically any type of implant, even if the type of implant placed in the jaw differs from the one on the basis of which the superstructure was made.

The invention also makes sure that screws with a relatively large diameter can be used for fixing the superstructure on the implants, which reduces the risk of these screws breaking.

To this aim, the superstructure is fixed on the head of the loadable implants, whereby a supporting element is mounted between this head and the superstructure, while maintaining a free space between the head of the non-loadable implants and the superstructure, whereby the height of this free space in the direction of the central axis of the implants corresponds to the height of the supporting element.

Practically, the superstructure is fixed to said loadable implants by means of a fixing element extending through said supporting element into a central recess in said loadable implants.

Advantageously, after a grow-in period at the end of which the non-loadable implants can be loaded, the superstructure is removed from said loadable implants and a supporting element is provided on said non-loadable implants. Next, the superstructure is fixed on the non-loadable and on the loadable implants whereby a supporting element is provided between each implant and the superstructure.

The invention also concerns a set for applying the method according to the invention. This set comprises a superstructure for a dental prothesis and at least one supporting element, a fastening screw and an implant whereby the latter must be placed in a bore hole in the jaw's bone. The implant is preferably provided with outside thread so that, by rotating it round its axis, it can be fixed in said bore hole until a head thereof extends at the surface of the bone.

The supporting element has an implant side and an opposite mounting side which are connected via an almost cylindrical recess, whereby said implant side has a first anti-rotation element which makes it possible to transmit a torsional movement on the implant via the supporting element. The shape of the implant's head is hereby complementary to the first anti-rotation element, such that this head can be fixed in a fitting manner to the implant side of the supporting element, whereby said recess in the supporting element is coaxial to a central recess in the implant opening in the head of the latter.

This set according to the invention is characterised in that said superstructure has a supporting area in which opens a cylindrical bore hole, such that this supporting area can be connected in a fitting manner on said mounting side of the supporting element, whereby said cylindrical bore hole is coaxial to said recess of the supporting element. Said fastening screw must extend through said bore hole of the superstructure and through said recess of the supporting element into said central recess of the implant in order to fix the superstructure to said implant, whereas said supporting element is clamped between the supporting area and the head of the implant.

According to an interesting embodiment of the set according to the invention, said implant side of the supporting element and the implant have fastening means making it possible to obtain an elastic, detachable coupling between the supporting element and the head of the implant.

Preferably, the set according to the invention comprises an implant driver, and said mounting side of the supporting element is provided with a second anti-rotation element which makes it possible to transmit a torsional movement on the supporting element. One far end of the implant driver hereby has a shape which is complementary to this second anti-rotation element, such that the implant driver can be attached in a fitting manner with this far end to the mounting side of the supporting element and coaxially to the latter.

Other particularities and advantages of the invention will become clear from the following description of a few embodiments of the invention; this description is given as an example only and does not limit the scope of the claimed protection in any way; the following reference figures refer to the accompanying drawings.

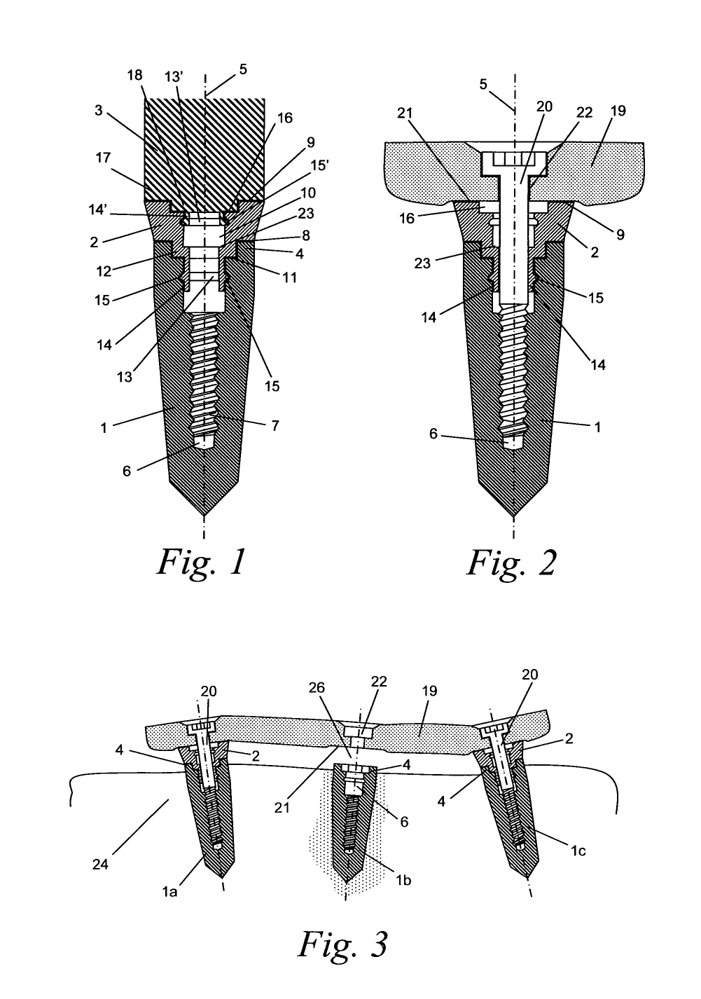

FIG. 1 is a schematic longitudinal section of an implant, a supporting element and a part of an implant driver according to an interesting embodiment of the invention.

FIG. 2 is a schematic longitudinal section of an implant, a supporting element, a fastening screw and a superstructure according to a preferred embodiment of the invention.

FIG. 3 is a schematic section of a jaw with three implants and a superstructure according to the invention.

In the different drawings, identical reference figures refer to identical or analogous elements.

A first embodiment of a set according to the invention is represented in FIG. 1. This set comprises a dental implant 1, a supporting element 2 and an implant driver 3.

The implant 1 is cylindrical and has outside thread, not represented in the figure, so as to fix it in a bore hole in the jaw bone by means of screwing. As soon as the implant 1 is fixed in a jaw, the head 4 of the implant will extend on the surface of the jaw's bone, such that a superstructure can be mounted on said head 4.

By implant is understood in this description a conventional dental implant, as well as an implant provided with an extension such as what is called an abutment.

Further, the implant 1 has an axis 5 and a central recess 6 opening in the head 4 thereof. This central recess 6 is provided with internal screw thread 7 making it possible to fix a screw in the recess 6.

Said supporting element 2 is ring-shaped and has an implant side 8 and an opposite mounting side 9 which are connected via an almost cylindrical recess 10.

The implant side 8 of the supporting element 2 is provided with a first anti-rotation element 11 which makes it possible to transmit a torsional movement on the implant 1 via the supporting element 2. To this end, the shape of the head 4 of the implant 1 is complementary to the first anti-rotation element 11, such that this head 4 can be attached in a fitting manner to the implant side 8 of the supporting element 2, as is represented in FIG. 1. The recess 10 in the supporting element 2 is coaxial to the central recess 6 of the implant 1 then.

Such an anti-rotation element 11 is formed, for example, of a hexagonal prism extending on the implant side 8 of the supporting element 2. The implant 1 has a corresponding hexagonal recess 12 then which is complementary to the anti-rotation element 11. When the supporting element 2 is fixed to the head 4 of the implant 1, the anti-rotation element 11 which is formed of a hexagonal prism will then be consequently countersunk in a fitting manner in the hexagonal recess 12 in the head 4 of the implant 1 by a hexagonal prism.

Further, said implant side 8 of the supporting element 2 and the implant 1 have fastening means making it possible to obtain an elastic, detachable coupling between the supporting element 2 and the head 4 of the implant 1.

In the embodiment of the invention, represented in FIG. 1, said fastening means are formed of a ring-shaped recess 13 in the wall of the central recess 6 of the implant 1 on the one hand, and of two rod-shaped protrusions 14 of the supporting element 2 provided with a bulge 15 on the other hand. These rod-shaped protrusions 14 extend as of the implant side 8 of the supporting element 2 parallel to the axis 5. Said protrusions 14 connect in particular to the anti-rotation element 11.

When the implant side 8 rests on the head 4 of the implant 1, said bulges 15 mesh in said ring-shaped recess 13, such that the supporting element 2 is fixed to the implant 1.

The rod-shaped protrusions 14 are made somewhat elastic, such that when a tensile force is exerted on the supporting element 2 so as to remove it from the implant 1, they will elastically deform somewhat and thus make it possible for the bulges 15 to remove themselves from the ring-shaped recess 13.

Naturally, numerous variants of these fastening means exist so as to form an elastic, detachable coupling. Thus, the wall of the central recess 6 of the implant 1 might have bulges, for example, whereby corresponding notches are provided in the supporting element 2. Further, an elastic ring can be provided on the supporting element 2, for example, which meshes in said ring-shaped recess 13 as soon as the supporting element 2 is fixed on the head 4 of the implant 1.

The set as represented in FIG. 1 further comprises what is called an implant driver 3. Such an implant driver makes it possible to drive the implant 1 through an opening provided to that end in a template on the one hand, and to manipulate the implant 1 and subject it to a rotation round its axis 5 on the other hand so as to screw it in a jaw's bone.

Such an implant driver 3 normally has a predominantly cylindrical body which is coaxially connected to the implant 1. For clarity's sake, FIG. 1 only represents the far end 17 of the implant driver 3 which is connected to the head 4 of the implant 1.

The implant driver 3 according to the invention can be mounted on said mounting side 9 of the supporting element 2. To this end, the mounting side 9 is provided with a second anti-rotation element 16 which makes it possible to transmit a torsional movement on the supporting element 2 via the implant driver 3. To this end, the shape of the far end 17 of the implant driver 2 is complementary to said second anti-rotation element 16, such that the implant driver 3 can be attached to the mounting side 9 of the supporting element 2 in a fitting manner and coaxially to the latter with this far end 17.

In particular, the anti-rotation element 16 in FIG. 1 is formed of a recess in the mounting side 9 of the supporting element 2 in the shape of a hexagonal prism. The far end 17 of the implant driver 3 thus has a corresponding hexagonal prism 18 which fits in the recess 16 concerned in the supporting element 2.

Further, said far end of the implant driver 3 and the supporting element 2 have fastening means making it possible to obtain an elastic, detachable coupling between the implant driver 3 and the supporting element 2. These fastening means are analogous to those described above, making it possible to fix the supporting element 2 in a detachable manner to the implant 1; they also comprise a ring-shaped recess 13′ and elastic or deformable protrusions 14′ with bulges 15′.

According to a variant of this embodiment of the set according to the invention, the set also comprises a superstructure 19 for a dental prothesis and at least one fastening screw 20. FIG. 2 schematically represents a cross section of such a superstructure 19.

This superstructure 19 has a supporting area 21 in which opens a cylindrical bore hole 22, such that this supporting area 21 can be connected in a fitting manner to the mounting side 9 of the supporting element 2. The cylindrical bore hole 22 is hereby coaxial to the recess 10 of the supporting element 2, such that a fastening screw 20 is provided extending through the bore hole 22 of the superstructure 19 and through said recess 10 of the supporting element 2 into the central recess 6 of the implant 2 so as to fix the superstructure 19 to said implant 1. The supporting element 2 is hereby clamped between the supporting area 21 and the head 4 of the implant 1.

Further, it may be useful in some cases to fix the supporting element 2 on the head 4 of the implant 1 by means of a screw. To this end, said recess 10 of the supporting element 2 has a collar 23 which makes it possible to fix said supporting element 2 with the implant side 8 to the head 4 of the implant 1. This screw is fixed via internal screw thread 7 provided in said central recess 6 of the implant 1 while the head of the screw rests on said collar 23.

Possibly, the set according to any one of the preceding embodiments of the invention may not contain an implant driver 3.

The mounting of a superstructure 19 on three implants 1a, 1b and 1c which are fixed in the bone 24 of a jaw 25 is illustrated in FIG. 3.

Implants 1a and 1c are hereby solidly anchored in the bone 24, for example such that they can be immediately loaded after having been put into place. Implant 1b was placed in a position in the jaw 25 where immediate loading of the implant 1b is not indicated.

Thus, implants 1a and 1c form loadable implants, whereas implant 1b forms a non-loadable implant. According to the invention, the superstructure 19 of a dental prothesis is mounted on the head of the loadable implants 1a and 1c. A supporting element 2 as already described above is hereby mounted between the head 4 of the loadable implants 1a and 1c and the superstructure 19, while a free space 26 is preserved between the head of the non-loadable implant 1b and the superstructure 19. The height of this free space 26 in the direction of the central axis 5 of the non-loadable implant 1b concerned is practically equal to the height according to the axis 5 of the implant concerned over which the supporting element 2 extends between the head 4 of the loadable implants 1a and 1c and the supporting area 21 concerned of the superstructure 19.

The superstructure 19 is fixed to said loadable implants 1a and 1c by means of a fastening element, in particular a fastening screw 20, extending through the recess 10 of said supporting element 2 into the central recess 6 in said loadable implants 1a and 1c.

As soon as the non-loadable implant 1b has sufficiently grown together with the bone 24 of the jaw 25 and has been solidly anchored such that it can be loaded, the superstructure 19 is removed from said loadable implants 1a and 1c, and a supporting element 2 is provided on the head of the originally non-loadable implant 1b. Next, the superstructure 19 is fixed on the non-loadable 1b and on the loadable implants 1a and 1c again, whereby a supporting element 2 is provided between every implant and the superstructure 19.

After the implants 1 have been placed in the bore holes provided to that end in the bone 24 of the jaw 25, the implant driver 3 is removed from the supporting element 2 by detaching said elastic, detachable coupling by exerting a light tensile force in relation to the supporting element 2.

If it is found that an implant 1 does not stand sufficiently solidly in the bone 24 and thus cannot be immediately loaded, the implant driver 3 will be removed from the head of the implant 1 together with the supporting element 2. As an elastic or deformable, detachable coupling is provided here between the supporting element 2 and the implant 1, it is not necessary to exert any torsion whatsoever, such that the implant 1 is not subjected unintendedly to a rotation round its axis 5 while the supporting element 2 is being removed.

Naturally, the invention is not restricted to the embodiments of the method and the set as described above and represented in the drawings.

Thus, the above-mentioned anti-rotation element 11 or 16 may assume all sorts of shapes. It may be formed, for example, of a recess or a raised volume with a cross section in the shape of a star, a polygonal prism, an asymmetrical shape, an ellipse, etc.

Also for said elastic, detachable coupling between the supporting element and the implant or between the supporting element and the implant driver can be provided numerous variants. The main function of this coupling is to make sure that, when handling the implant with the implant driver, they remain connected to one another.

For clarity's sake it should be mentioned that, when the implant is provided with an abutment, this abutment will assume the function of the implant's head 4. Thus, the supporting element 2 is placed between the abutment and the supporting area 21 of the superstructure 19 in order to fix the latter to the implants. To the professional, the function and design of such an abutment is clearly different from the supporting element 2 according to the invention.

1. Method for mounting a superstructure (19) of a dental prothesis on implants (1) which are provided in the bone (24) of a patient's lower or upper jaw (25), whereby each of these implants (1) has a head (4) on which said superstructure (19) must be fixed and whereby these implants (1) form loadable (1a, 1c) and non-loadable (1b) implants, characterised in that the superstructure (19) is fixed on the head (4) of the loadable implants (1a,1b), whereby a supporting element (2) is mounted between said head (4) and the superstructure (19), whereas a free space (26) is preserved between the head (4) of the non-loadable implants (1b) and the superstructure (19), whereby the height of this free space (26) in the direction of the central axis (5) of the implants (1) corresponds to the height of the supporting element (2).

2. Method according to claim 1, whereby said superstructure (19) is fixed to said loadable implants (1a, 1c) by means of a fastening element (20) extending through said supporting element (2) into a central recess (6) in said loadable implants (1a,1b).

3. Method according to claim 1, whereby said supporting elements (2) are fixed in an elastically detachable manner to the head (4) of said implants (1, 1a, 1b, 1c).

4. Method according to claim 1, whereby the superstructure (19) is subsequently removed from said loadable implants (1a, 1c), and a supporting element (2) is provided on said non-loadable (1b) implants, whereby the superstructure (19) is then fixed on the non-loadable (1b) and on the loadable (1a, 1c) implants, whereby a supporting element (2) is provided between every implant and the superstructure (19).

5. Set with a superstructure (19) for a dental prothesis and with at least one supporting element (2), a fastening screw (20) and an implant (1) whereby 30 the latter must be placed in a bore hole in a jaw's bone (24), whereby the implant (1) has outside thread so that, by rotating it round its axis (5), it can be fixed in said bore hole until a head (4) thereof extends at the surface of the bone (24), whereby the supporting element (2) has an implant side (8) and an opposite mounting side (9) which are connected via an almost cylindrical recess (10), whereby said implant side (8) of the supporting element (2) has a first anti-rotation element which makes it possible to transmit a torsional movement on the implant (1) via the supporting element (2), whereby the shape of the head (4) of the implant (1) is complementary to the first anti-rotation element (11), such that this head (4) can be fixed to the implant side (8) of the supporting element (2) in a fitting manner, such that said recess (10) in the supporting element (2) is coaxial to a central recess (6) in the implant (1) which opens in the head (4) of the latter, characterised in that said superstructure (19) has a supporting area (21) in which a cylindrical bore hole (22) opens, such that this supporting area (21) can be connected in a fitting manner to said mounting side (9) of the supporting element (2), whereby said cylindrical bore hole (22) is coaxial to said recess (10) of the supporting element (2), whereby said fastening screw (20) must extend through said bore hole (22) of the superstructure (19) and through said recess (10) of the supporting element (2) into said central recess (6) of the implant (1) in order to fix the superstructure (19) to said implant (1), while said supporting element (2) is clamped between the supporting area and the head (4) of the implant (1).

6. Set according to claim 5, whereby said implant side (8) of the supporting element (2) and the implant (1) have fastening means (13,14,15) which make it possible to obtain an elastic, detachable coupling between the supporting element (2) and the head (4) of the implant (1).

7. Set according to claim 5, whereby it comprises an implant driver (3) and whereby said mounting side (9) of the supporting element (2) is provided with a second anti-rotation element (16) making it possible to transmit a torsional movement onto the supporting element (2), whereby the shape of one far end (17) of the implant driver (3) is complementary to said second anti-rotation element (16), such that the implant driver (3) can be attached to the mounting side (9) of the supporting element (2) in a fitting manner and coaxially to the latter with this far end (17).

8. Set according to claim 7, whereby said far end (17) of the implant driver (3) and the supporting element (2) have fastening means (13′,14′,15′) making it possible to obtain an elastic, detachable coupling between the implant driver (3) and the supporting element (2).

9. Set according to claim 5, whereby said recess (10) of the supporting element (2) has a collar (23) which makes it possible to fix this supporting element (2) with the implant side (8) to the head (4) of the implant (1) by means of a screw which is fixed via internal screw thread (7) provided in said central recess (6) of the implant (1) while the head of the screw (20) rests on said collar (23).

10. Set according to claim 5, whereby said implant (1), said supporting element (2) and said implant driver (3) are connected in a detachable manner and form a whole, whereby an elastic, detachable coupling is formed between the supporting element (2) and the head (4) of the implant (1) by said corresponding fastening means (13,14,15), and an elastic, detachable coupling is formed between the implant driver (3) and the supporting element (2) by said corresponding fastening means (13′,14′,15′).
